(19) United States
(12) Patent Application Publication
(10) Pub. No.: US 2009/0257225 A1
(43) Pub. Date: Oct. 15, 2009

(54) Method and device for lamp having multiple light illuminating angles

(75) Inventor: Jianli Sun, Yuyao (CN)

Correspondence Address: BACON & THOMAS, PLLC, 625 SLATERS LANE, FOURTH FLOOR, ALEXANDRIA, VA, 22314-1176, US

(73) Assignee: ZHEJIANG HOWELL ILLUMINATING TECHNOLOGY CO., LTD., Yuyao (CN)

(21) Appl. No.: 12/081,262

(22) Filed: Apr. 14, 2008

(51) Int. Cl. F21V 7/00

(52) U.S. Cl. 362/247

(57) ABSTRACT

This invention provides a method and a device for lamp having multiple illuminating angles. The inner surface of the lamp shade have a plurality of locating faces arranged with different angle all round the inner surface of the lamp shade, the light emitting diodes or other illuminating elements being installed respectively on the locating faces. Each light emitting diode can emit light perpendicularly with its locating face so as to control the illuminating angle and scope of lamp.

### BACKGROUND OF THE INVENTION

(1) Field of the invention

This invention relates to a method and device for lamp having multiple light illuminating angles, especially a lamp having a plurality of locating faces formed and arranged with different tangent angle around the inner side of the lamp shade, the light emitting diodes installed respectively on the locating faces can emit different angle light according to the tangent angle of the locating faces so as to control the illuminating angle and scope.

(2) Description of the Prior Art

The light source is very important to human life and economic development. At present, the illuminating technology is improved toward low energy consumption and low environmental pollution. For the conventional lamp bulb or fluorescent lamp, the light emitting diode have many advantages, such as small size, long service life, low energy consumption and low environmental pollution and can be used widely on illuminating industrials. However, the light emitting diode is a kind of semiconductor element whose illuminating angle is smaller than that of the conventional lamp bulb or the conventional fluorescent lamp. Accordingly, the light emitting diode used on illuminating lamp is limited.

### SUMMARY OF THE INVENTION

It is therefore the main object of this invention to provide a method and a device for lamp having multiple illuminating angles, the lamp having a plurality of locating faces formed and arranged with different tangent angle round the inner side of the lamp shade. The light emitting diodes or other illuminating elements are installed respectively on the locating faces. Each light emitting diode can emit light perpendicularly with its locating face so as to control the illuminating angle and scope of lamp.

### BRIEF DESCRIPTION OF THE DRAWINGS

In the drawings, which illustrate the preferred embodiments and modes of operation of this invention, and in which like reference characters designate the same or similar parts throughout the several views:

FIG. 1 is a partial sectional view showing a method and device for lamp having multiple light illuminating angles of this invention;

FIG. 2 to FIG. 6 is exploded views showing other embodiments of this invention;

FIG. 7 is a partial sectional view showing the combination and illuminating status of the embodiment in FIG. 6;

FIG. 8 is a plan view showing lateral illuminating angle of this invention; and

FIG. 9 is a plan view showing the longitudinal illuminating angle of this invention.

### DETAILED DESCRIPTION OF THE PREFERRED EMBODIMENTS

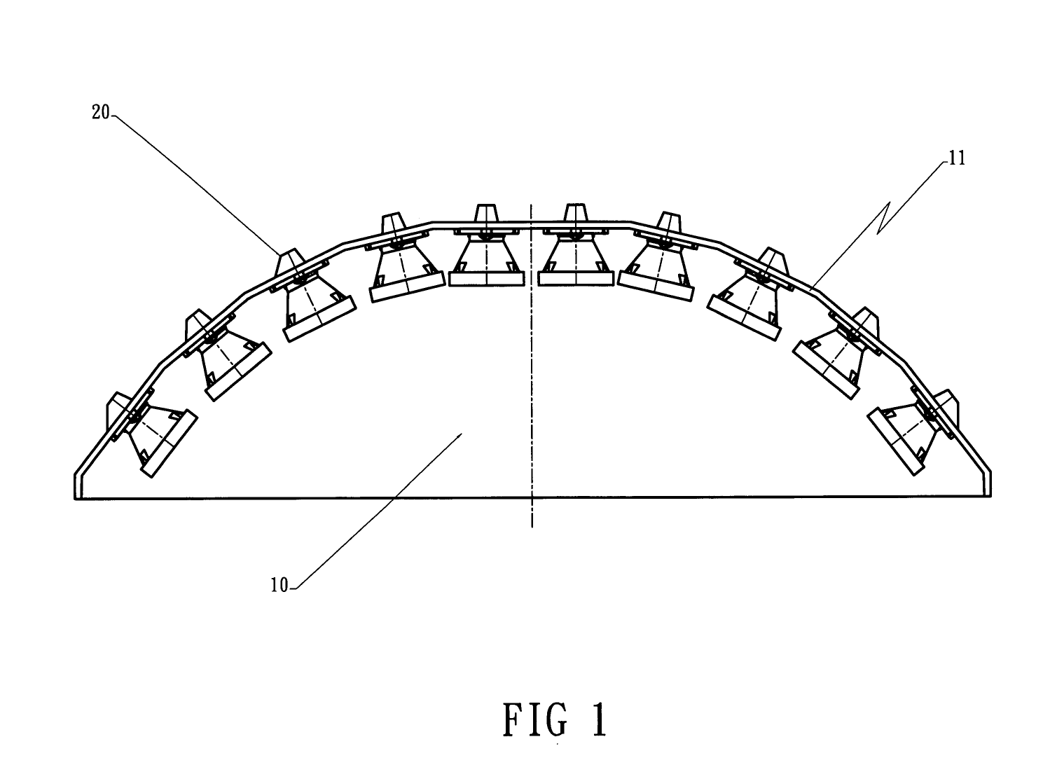

Referring to FIG. 1, the present invention relates to a method and device for lamp having multiple light illuminating angles. The lamp shade 10 of this invention have a plurality of locating faces 11 formed and arranged with different tangent angle around the inner side of the lamp shade 10. A plurality of light emitting diodes 20 or other illuminating elements are installed respectively on the locating faces 11, each light emitting diode 20 or illuminating element can emit light perpendicularly with its locating faces 11 so as to control the illuminating angle and scope of lamp. However, the number and the tangent angle of the locating faces around the inner side of the lamp shade 10 is determined according to the desired illuminating angle or the type of lamps.

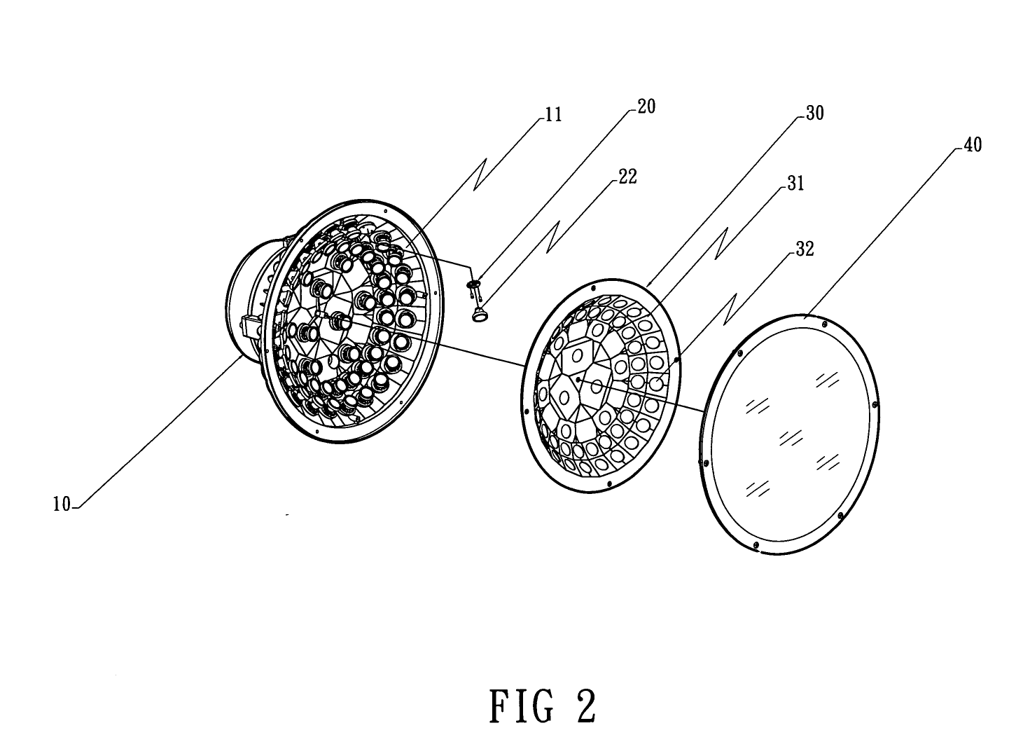

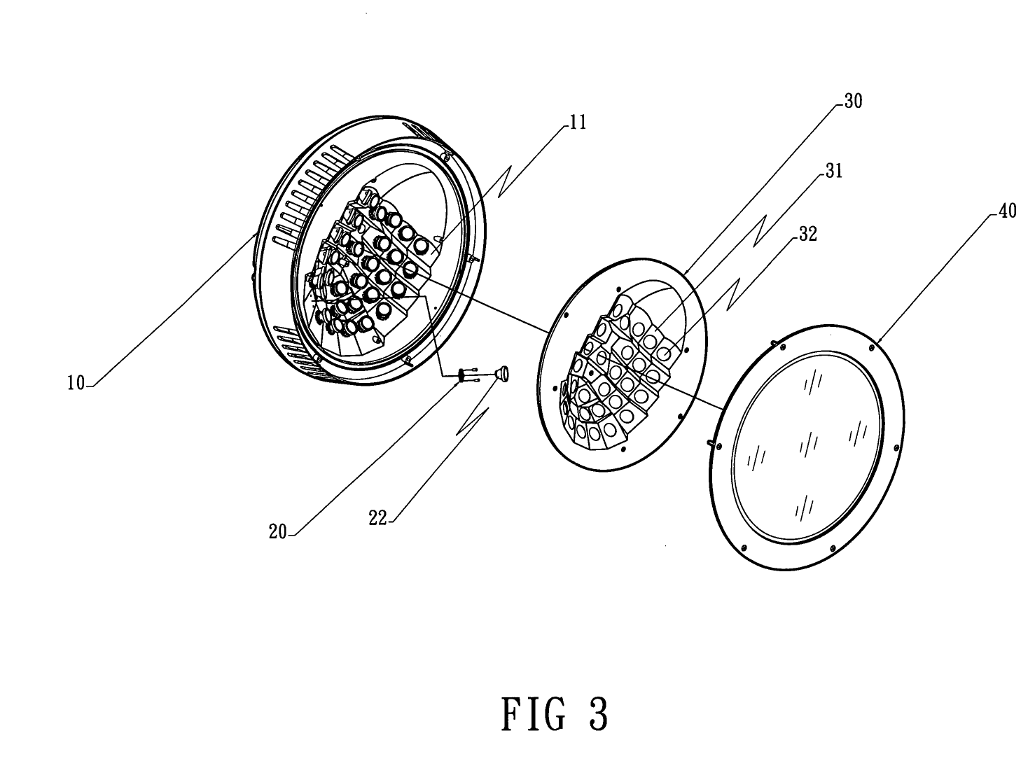

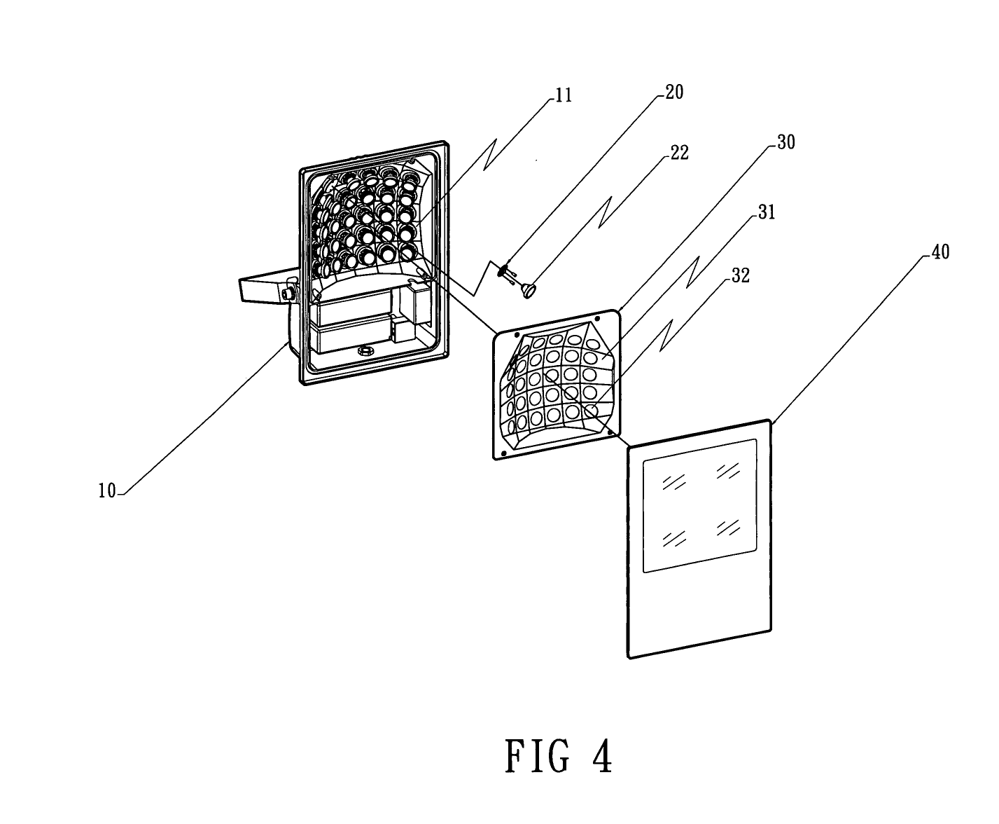

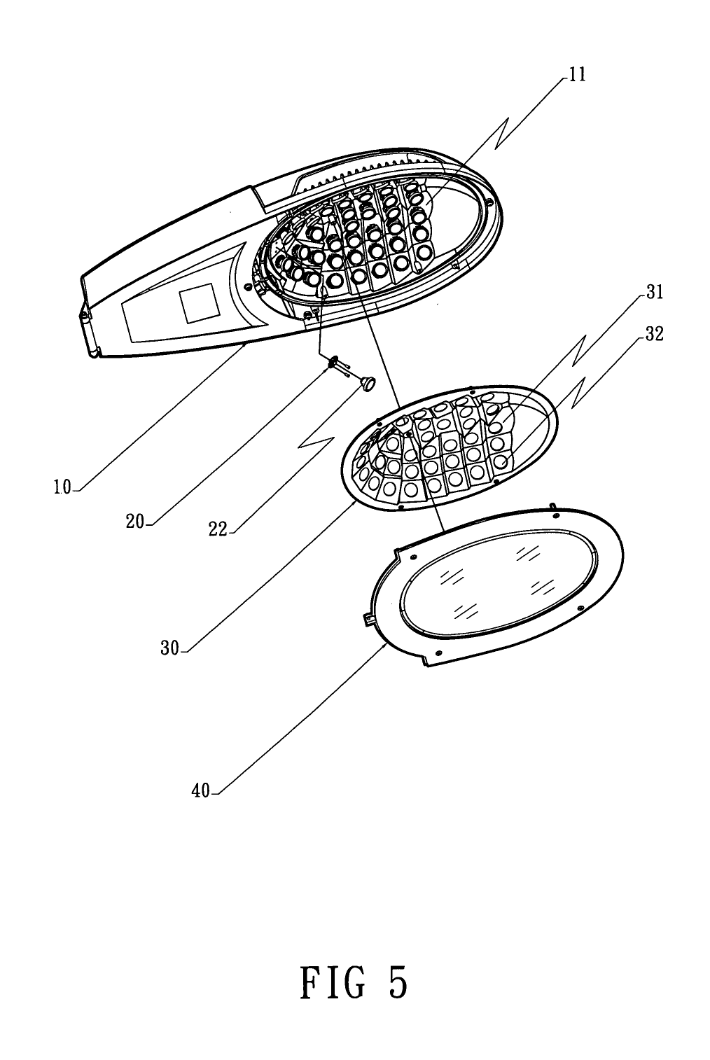

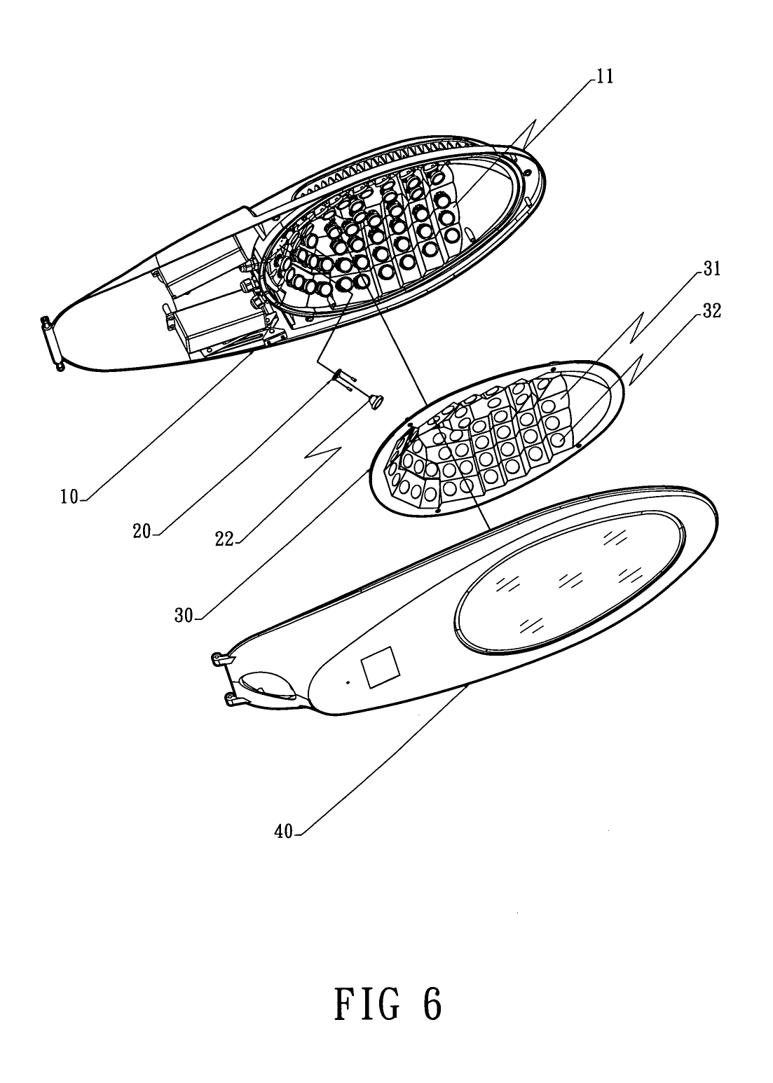

FIG. 2 to FIG. 6 shows other embodiment of this invention. In spite of the type of the lamp, the inner side of the lamp shade 10 can be formed into a plurality of locating faces 11 with different tangent angle. The light emitting diodes 20 are fixed respectively on the locating faces 11 by screws, each light emitting diode 20 being fitted with a light gathering cup 22 for gathering emitting light. A reflection disk 30 is installed on the inner side of the lamp shade 10, the outline of the reflection disk 30 matching with the inner side of the lamp shade. On the reflection disk 30 has a plurality of reflection faces 31 and through holes 32 aiming respectively to the light emitting diodes 20, further the diameter of the through hole 32 being smaller than that of the light gathering cup 22 so as to locate the light gathering cup. Finally, a transparent dust-proof cover 40 is installed on the lamp shade 10 for protecting the light emitting diodes 20.

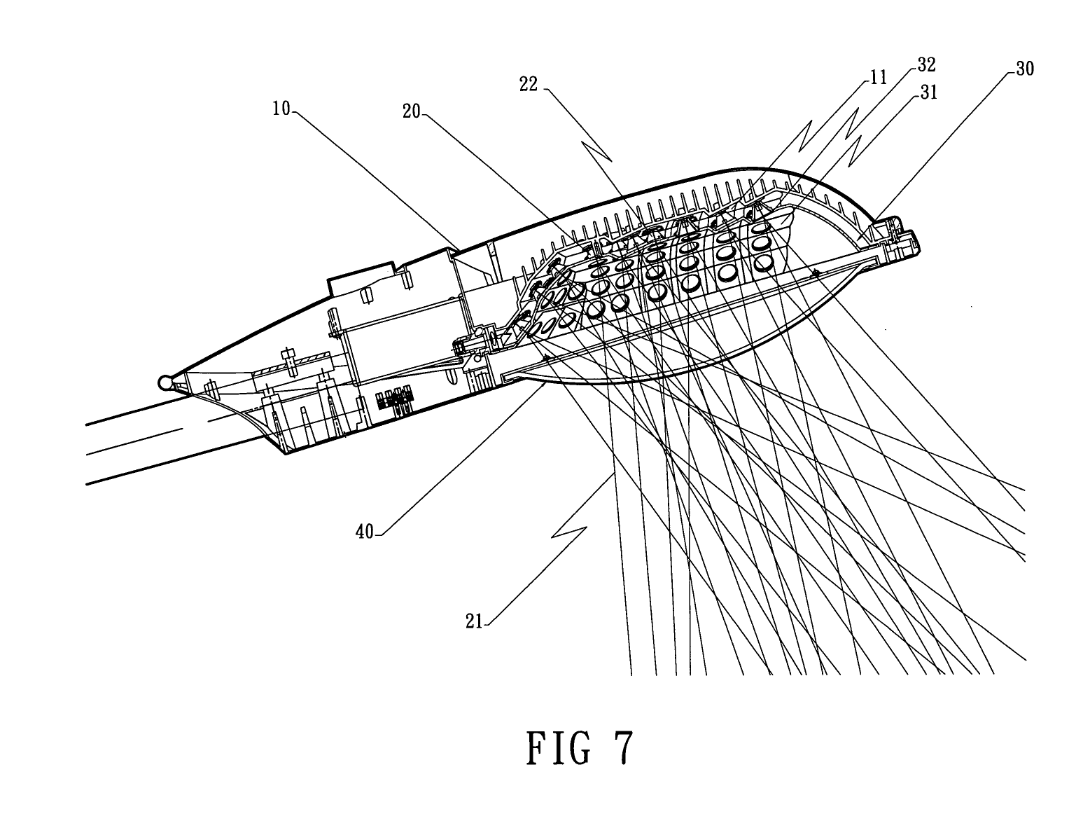

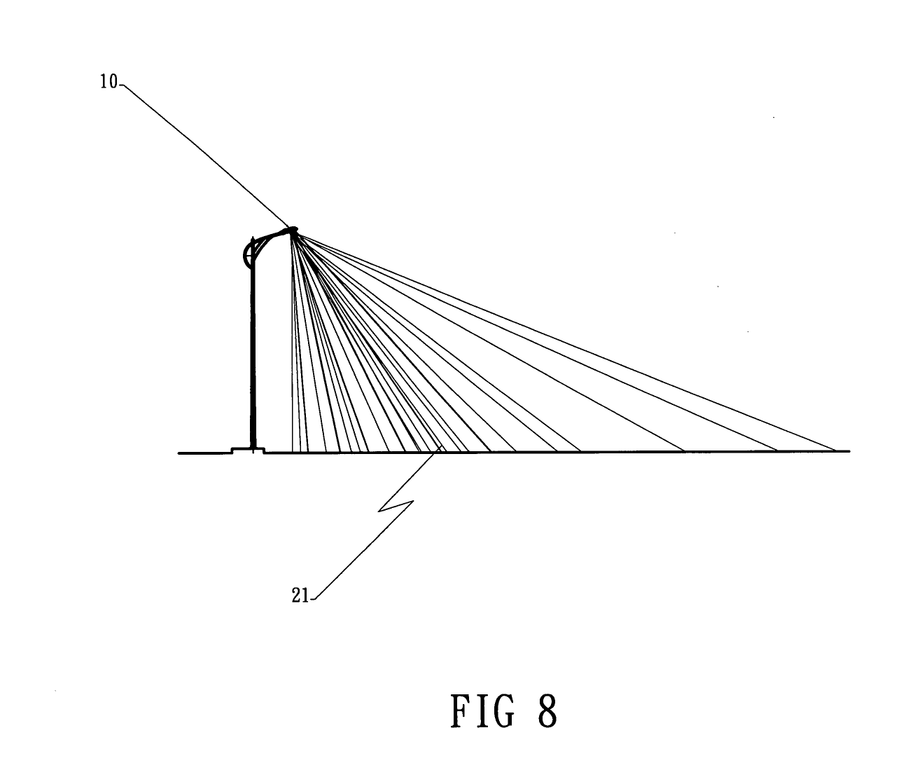

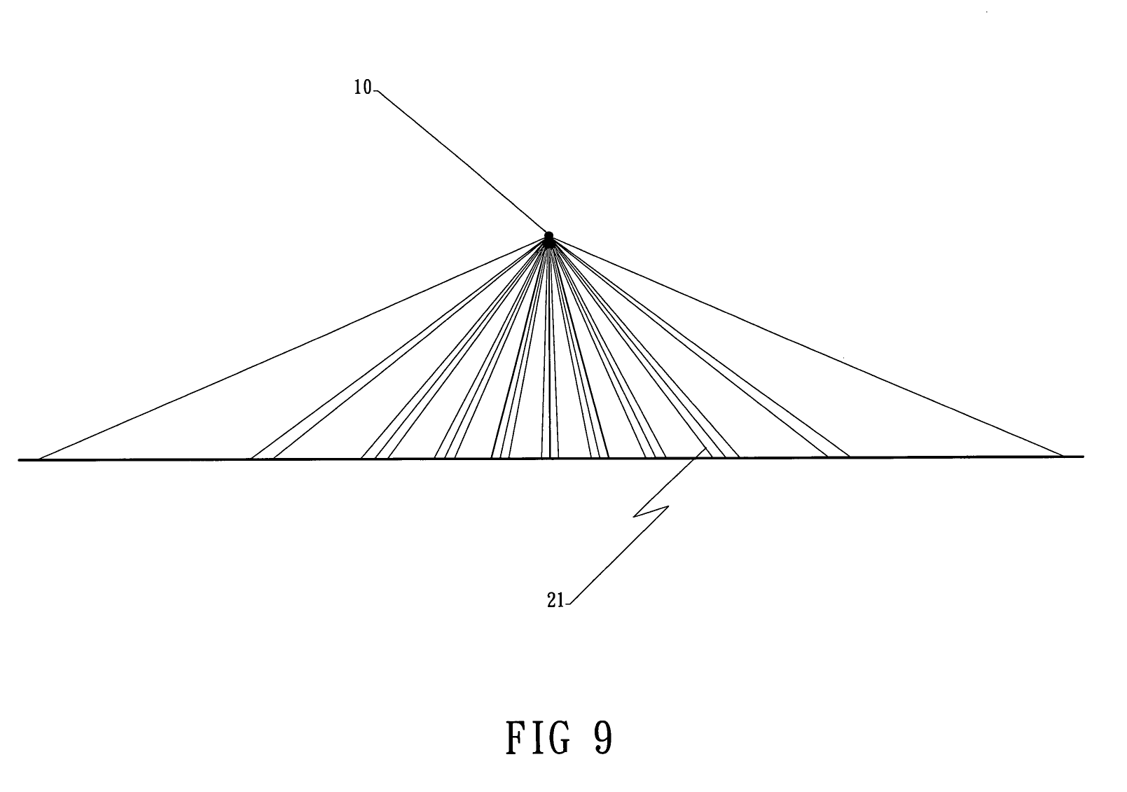

The light emitting diodes 20 installed respectively on the locating faces 11 can emit different angle light by the different tangent angle of the locating faces 11, such as shown in FIG. 7. Accordingly, the illuminating angle or scope of lamp can be controlled by the tangent angle of the locating faces 11, such as shown in FIG. 8 and FIG. 9.

It is understood by those skilled in the art that the foregoing description is a preferred embodiment of the disclosed device and that various changes and modifications may be made in the invention without departing from the spirit and scope thereof.

I claim:

1. A method and device for lamp having multiple light illuminating angles comprising:
a lamp shade, the inner side of the lamp shade having a plurality of locating face formed and arranged with different tangent angle;
a plurality of illuminating elements installed respectively on said locating faces;
a plurality of light gathering cups fitted respectively on said illuminating elements;
a reflection disk installed on said lamp shade, the outline of the reflection disk matching with the inner side of said lamp shade and having a plurality of reflection faces and through holes aiming respectively to said illuminating elements;
a transparent dust-proof cover installed finally on the lamp shade for protecting said light emitting diodes;
the emitting light of each said illuminating element is perpendicular to its locating faces so as to control the illuminating angle and scope.

2. A method and device for lamp having multiple light illuminating angles as claimed in claim 1, wherein the illuminating element is light emitting diode.
